(19) United States
(12) Patent Application Publication
(10) Pub. No.: US 2026/0356253 A1
(43) Pub. Date: Nov. 12, 2026

(54) CAR SEAT WITH ANCHORING SYSTEM

(71) Applicant: Evenflo Company, Inc., Miamisburg, OH (US)

(72) Inventors: Longcheng CAI, Kunshan City (CN); Guy DINGMAN, Idaville, IN (US); Xuegang HU, Kunshan City (CN); Charles H. KEEGAN, Milton, MA (US); Shain A. SAUCIER, Charlotte, NC (US); Joel WENNERSTROM, Roslindale, MA (US); Xiaoyong YANG, Kunshan City (CN)

(21) Appl. No.: 19/204,062

(22) Filed: May 9, 2025

(51) Int. Cl. B60N 2/28

(52) U.S. Cl. CPC B60N 2/2821; B60N 2/2887

(57) ABSTRACT

The disclosure provides a child's safety seat for a vehicle. The base of the child safety seat includes an arm assembly for securing the webbing, a locking assembly for securing the webbing, and biasing mechanisms for tensioning the webbing. These features apply various forces and tensioning to remove slack from the webbing during installation of the base while preventing over-tensioning. When the arm assembly is in an open position, biasing mechanisms tension to remove slack while allowing freedom for a user to connect the webbing to vehicle anchors. When the arm assembly is in a closed position, the arm assembly and the locking assembly secure the webbing at multiple positions in the base, thus ensuring sufficient tension in the webbing such that the base is safely installed.

### BACKGROUND

Conventional child safety seats, used when transporting children in cars or other vehicles, typically consist of a base secured to the vehicle and a seat that is either permanently or removably coupled to the base. The base may be secured to the vehicle using the vehicle's seat belt, or a standardized anchoring system such as the Lower Anchors and Tethers for Children (LATCH) system, in which the base is connected to anchors embedded in the vehicle seat via tethers or straps (also known as “webbing”). Achieving the proper levels of tension for the seat belt or LATCH webbing is an important step to secure the safety seat base firmly against the vehicle seat.

### BRIEF DESCRIPTION OF THE DRAWINGS

The present disclosure is described in detail below with reference to these figures.

FIG. 1A illustrates a perspective view of a base for a child car seat with an arm assembly in a closed position in accordance with aspects herein.

FIG. 1B illustrates a perspective view of the base of FIG. 1A with an arm assembly in an open position in accordance with aspects herein.

FIG. 1C depicts a top-down view of the base of FIG. 1A with the arm assembly in the open position in accordance with aspects herein.

FIG. 2A illustrates an exploded view of the base of FIG. 1A with an arm assembly in the open position in accordance with aspects herein.

FIG. 2B illustrates a diverter formed with or integrated into the base of FIG. 2A in accordance with aspects herein.

FIG. 2C illustrates a portion of the webbing locking assembly of FIG. 2A in accordance with aspects herein.

FIG. 3 illustrates a cross-sectional view of the base of FIG. 1B in accordance with aspects herein.

FIG. 4 illustrates a cross-sectional view of the base of FIG. 1A in accordance with aspects herein.

FIG. 5 illustrates the routing of a configuration for a single side webbing in the base of FIG. 1B in accordance with aspects herein.

FIG. 6A illustrates a magnified view of a webbing locking assembly of the arm assembly in the open position of FIG. 1B in accordance with aspects herein.

FIG. 6B illustrates a magnified view of the webbing locking assembly of the arm assembly in the closed position of FIG. 1A in accordance with aspects herein.

FIG. 7 illustrates a bottom view of the base, showing the interior components of the base of FIGS. 1A and 1B in accordance with aspects herein.

### DETAILED DESCRIPTION

In the following detailed description, reference is made to the accompanying drawings, which form a part hereof. In the drawings, similar symbols identify similar components, unless context dictates otherwise. The illustrative examples described in the detailed description and drawings are not meant to be limiting and are for explanatory purposes. Other examples may be utilized, and other changes may be made, without departing from the spirit or scope of the subject matter presented herein. It will be readily understood that the aspects of the present disclosure, as generally described herein and illustrated in the drawings, may be arranged, substituted, combined, and designed in a wide variety of different configurations, each of which are explicitly contemplated and form a part of this disclosure.

It should be noted that some of the terms used herein may be relative terms. For example, the terms “upper” and “lower” and the terms “forward” (or “front”) and “rearward” (or “rear” or “back”) are relative to each other in location, i.e., an upper component is located at a higher elevation than a lower component in a given orientation, but these terms may change if the device is flipped. An intermediate component, on the other hand, is always located between an upper component and a lower component regardless of orientation. The terms “horizontal” and “vertical” are used to indicate direction relative to an absolute reference, i.e., ground level. However, these terms should not be construed to require structures to be absolutely parallel or absolutely perpendicular to each other. For example, a first vertical structure and a second vertical structure are not necessarily parallel to each other. The terms “top” and “bottom” are used to refer to surfaces where the top is always higher than the bottom relative to an absolute reference, i.e., the surface of the Earth when the component is used as intended. The terms “upwards” or “upwardly” and “downwards” or “downwardly” are also relative to an absolute reference; upwards is always against the gravity of the earth. The terms “forward” and “rearward” or “rear” with respect to a position or orientation are opposite one another along a common direction, and an “intermediate” position is always located between a forward position and a rearward position.

The terms “operative to” and “configured to” and similar terms are used herein to describe that a particular component has certain structural features designed to perform a designated function. Such components should be construed as having the expressed structure, with the designated function being considered part of the structure. As used herein and as will be appreciated by those skilled in the art, the term “car seat” encompasses car seats, safety seats, restraints, boosters, and the like for children, infants, toddlers, and the like.

Unless indicated otherwise, all measurements provided herein are taken when a component(s) is at standard ambient temperature and pressure (298.15 K and 100 kPa). As used herein, the terms “substantially” and “about” mean within ±5% of an indicated value.

At a high level, the safe and secure installation of child safety seats in vehicles remains an important concern, as proper installation ensures that the safety seat can effectively protect a child in the event of an accident. Despite the availability of standardized systems like LATCH, user effort is still required to achieve proper tension for the webbing to secure the safety seat base firmly against the vehicle seat. Conventional LATCH systems often require manually pulling the webbing to tighten it or using basic tensioning mechanisms integrated into the child safety seat assembly. These methods may be applied differently among various users leading to inconsistent results. Improperly tensioned LATCH systems can lead to instability, reducing the effectiveness of the child restraint system and compromising the safety of the child.

In some systems, an arm assembly may be pivotally coupled to the base between an open position and a closed position. In the closed position, the arm assembly clamps portions of the webbing against the base, which prevents the clamped portions of the webbing from shifting relative to the base. If the webbing has been properly attached to the vehicle anchors and properly tightened before the arm assembly is closed, the car seat may be securely and safely fastened to the vehicle seat. However, if the webbing is not tightened enough, there will be too much slack in the webbing when the arm assembly is closed, and the car seat will not be sufficiently fastened. Conversely, if there is too much tension in the webbing, a user may have difficulty in fully closing the arm assembly to clamp the webbing into place, requiring readjustment of the webbing.

To address these issues, aspects herein are directed to a car seat base with an arm assembly integrated into the child safety seat assembly that, in addition to being configured to clamp portions of webbing against the base, also includes a separate webbing locking assembly in the arm assembly, and one or more biasing mechanisms (e.g., springs) that attach one end of the webbing to the base. The base has a structure that is configured to removably hold an infant carrier or a child safety seat, such that the seat can be secured to the base for automobile travel.

When the arm assembly is in an open position and the webbing is connected to a vehicle anchor (e.g., via a LATCH connector of the base), the biasing mechanisms apply a tension throughout the webbing that removes a portion of slack from the webbing without requiring any action on behalf of a user. When the arm assembly is moved to its closed position, the webbing locking assembly engages the webbing to “cut off” the section of the webbing attached to the vehicle anchor from the effects of the biasing mechanism while maintaining an appropriate level of tension in the section of the webbing attached to the vehicle anchor so that the arm assembly can then be moved to the fully closed position in order to clamp the webbing into position to effectively secure the car seat to the vehicle. In aspects herein, the base includes a first webbing that corresponds to a first side or half (e.g., right side) of the base, and a second webbing that corresponds to the second side or half (e.g., left side) of the base. For simplicity and conciseness, the description herein may focus on describing a webbing with regard to one side or half of the base, though it will be understood from the figures and descriptions that the base includes a plurality of webbing.

In some aspects, the webbing locking assembly includes a first transverse member and a second transverse member-also referred to herein as “locking” bars. The first and second transverse members are positioned between two longitudinal members of an arm assembly. The first locking bar and the second locking bar are adjacent to but offset from each other and rotate about the pivot axis of the arm assembly along different radiuses so that the first and second locking bars move different linear distances for the same amount (or angle) of rotation of the arm assembly. A webbing may be threaded between the first and second locking bars so that as the arm assembly is moved from an open to a closed position, portions of the same webbing are pressed tightly against each other, with the resulting friction preventing the webbing from shifting relative to the locking bars. In various aspects, one of the locking bars can be shifted in response to rotation of the arm assembly, in order to change a size of a gap between said locking bars.

In various aspects, the base also includes one or more structures for routing the webbing relative toward the arm assembly when in a closed position and relative to the base. In aspects, a structure may be used to redirect the orientation of the webbing from a generally lateral orientation relative to the first and second sides of the base (e.g., from the right side toward a midline of the base, and from a left side toward a midline of the base) to a generally longitudinal orientation relative to a front of the base and a rear of the base. The portion of the webbing that is clamped by the arm assembly is in the generally lateral orientation, and another portion of the webbing that is secured by the webbing locking assembly is in the generally longitudinal orientation, in various aspects.

When the arm assembly is in an open position, a distal portion of the arm assembly is raised upward and away from the base, and the biasing elements concurrently pull on one end of the tensioning webbing to exert force through the length of the tensioning webbing, as said webbing is being routed from being attached to a vehicle anchor through a LATCH connector, through a webbing routing pathway in the base that further connects with a biasing mechanism, and is secured to the base of the car seat. Because the webbing is not locked in place by the arm assembly, however, it can be lengthened or shortened manually, e.g., by a user pulling out additional webbing during the act of securing the LATCH connector to the vehicle anchor, or, after the connection is completed, the biasing element supplying tension to the webbing to remove slack. If the LATCH webbing is connected to a vehicle anchor, then the biasing mechanism will pull out excess slack until the LATCH webbing and tensioning webbing are taut.

When the arm assembly is pushed downward and into the base, the webbing wraps around the locking bars near the arm assembly pivot and is held in place, fixing the length of the webbing extending outward from the clamping area. As the arm assembly continues downward and is locked into place, the side bars then contact and apply additional tension to the webbing while clamping the webbing firmly into place.

The biasing mechanism in combination with the webbing locking assembly and the clamping of the webbing by the arm assembly thus helps to overcome the problem in conventional car seat anchoring systems of having too much or too little tension in the webbing prior to locking an arm assembly into place. As described above, too much tension in the webbing results in the arm assembly being difficult or unable to be closed completely for installation of the base. Conversely, if there is insufficient tension (e.g., if there is slack) in the webbing, then the base may not be secured sufficiently to the vehicle seat even after the arm assembly is fully closed, resulting in undesirable excess movement of the car seat when load-bearing (i.e., when a child is secured into the car seat), when the vehicle is in motion, and particularly in the event of a collision or other accident. Furthermore, a car seat in accordance with the present disclosure is simple and intuitive to use. The user does not have to actuate a separate mechanism to extend, retract, tighten, or loosen the webbing prior to closing the arm assembly; the webbing may be adjusted to position the base and attach the webbing to the vehicle anchors, and any excess webbing pulled out of the assembly during this process is automatically retracted into the base by the biasing mechanism prior to the closing of the arm assembly, thus automatically tensioning the webbing by removing slack.

The above features and advantages and other features and advantages of the present teachings are readily apparent from the following detailed description for carrying out the present teachings when taken in connection with the accompanying drawings, as discussed hereinafter.

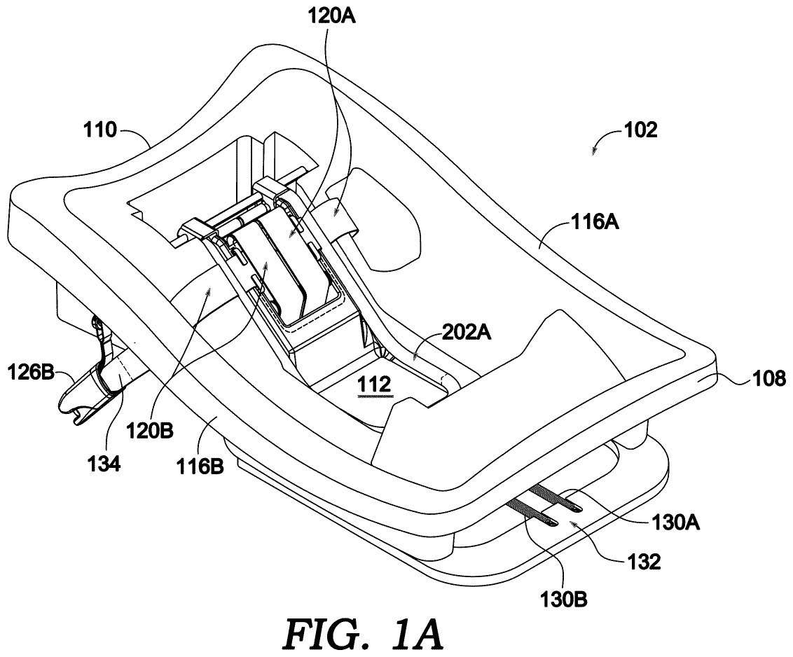

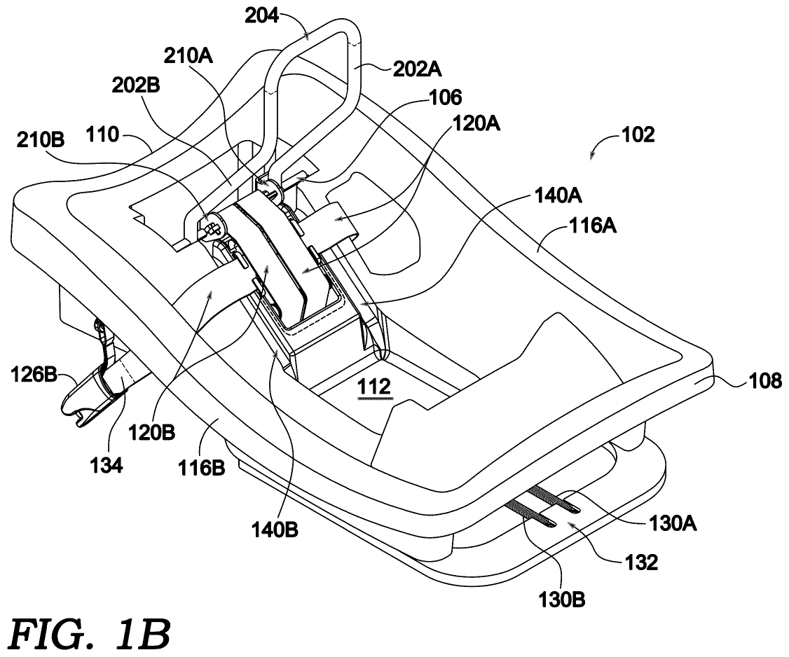

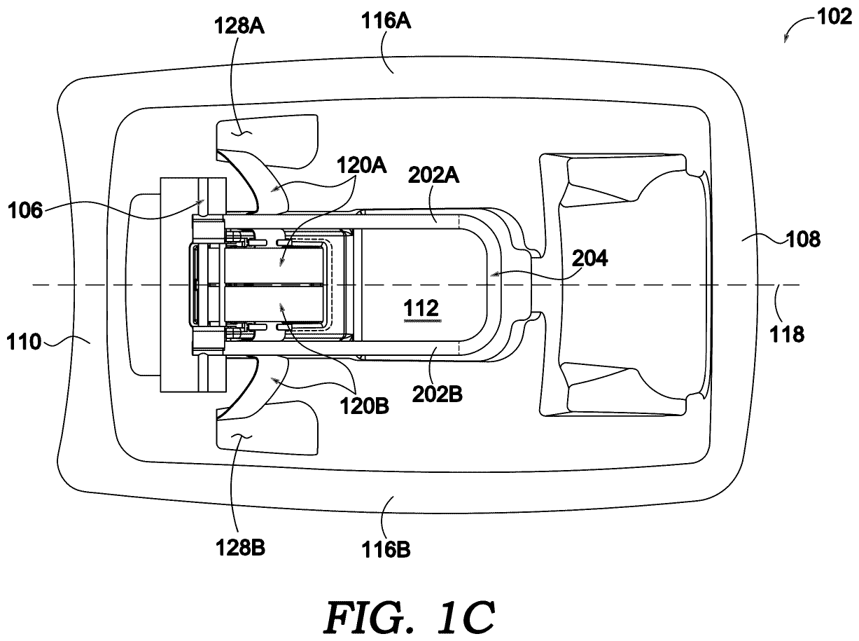

In accordance with aspects of the disclosure, aspects of car seats are illustrated in various levels of specificity in FIGS. 1A-7. Beginning with FIGS. 1A-C, a base 102 for a child seat is shown. The base 102 includes an arm assembly 104 pivotally coupled to the base 102 by a pivot member 106 or pivot rod 106, with FIG. 1A showing the arm assembly in a first, closed (“locked”) position and FIGS. 1B and 1C showing the arm assembly 104 in a second, open (“unlocked”) position.

The base 102 has a front side 108, a back side 110, a top surface 112 extending from the front side 108 to the back side 110, and a bottom surface 114 opposite the top surface 112 and extending from the front side 108 to the back side 110. The base 102 also has a first side 116A and a second side 116B that is opposite the first side 116A, such that the first side 116A and second side 116B are positioned opposite each other relative to a longitudinal midline 118 that bisects the base 102 and extends from the front side 108 to the back side 110, as illustrated in the top-down view of FIG. 1C. In the examples of FIGS. 1A to 1C, the first side 116A corresponds to a right side or right half of the base 102, and the second side 116B corresponds to a left side or left portion of the base 102, for instance. However, it will be understood that in other aspects not shown herein, the first side 116A corresponds to a left portion of the base 102, and the second side 116B corresponds to a right portion of the base 102.

When the base 102 is positioned on a vehicle seat, the bottom surface 114 faces downwards towards and is configured to contact the seat of the vehicle, the top surface 112 faces upwards and away from the seat of the vehicle, the front side 108 of the base is oriented and positioned towards the front of the vehicle, and the back side 110 of the base 102 is oriented and positioned towards the seat back in the vehicle. The bottom surface 114 is configured so that it stably rests upon the surface of the vehicle seat, and the back side 110 is configured to be adjacent to and contact the seat back of the vehicle seat. When the base 102 is positioned on the vehicle seat, the top surface 112 is configured to allow access to the arm assembly 104, which can be manually manipulated back and forth between the open “unlocked” position shown in FIG. 1B and the closed position shown in FIG. 1A. When the arm assembly is in the closed “locked” position, a carrier seat shell (not shown) may be mounted into the base 102.

The base 102 includes a first webbing 120A that is housed in and traversed through the first side 116A of the base 102 and a second webbing 120B that is housed in and traverses through the second side 116B of the base 102. Hereinafter, the terms “webbing” and “webbing body” are used interchangeably. In the example shown in FIGS. 1A and 1B, the first webbing 120A corresponds to and has a routing pathway that traverses through the first side 116A of the base 102 while the second webbing 120B corresponds to and has a routing pathway that traverses through the second side 116B of the base. As used herein, the term “webbing” refers to a strong, flexible fabric or material used in safety restraint systems, such as child car seats and LATCH systems. It is typically made from durable and high-tensile-strength synthetic fibers, such as polyester or nylon, designed to withstand significant forces during a collision. In various aspects, the first webbing 120A and the second webbing 120B are positioned opposite each other relative to the longitudinal midline 118 that bisects the base 102. Each of the webbings is a continuous strip or length of webbing, though the webbings may be discussed herein as having various portions for ease and clarity in this discussion.

The first webbing 120A comprises a first webbing first end 122 and a first webbing second end 124. The first webbing first end 122 is attached to a connector 126A that is configured for releasable attachment to a vehicle anchor in a vehicle seat. In one example, the connector 126A may be an International Standards Organization FIX, known as an ISOFIX connector. As shown in FIGS. 1A-C, the base 102 includes an opening 128A formed in the housing of the base 102, through which the first webbing first end 122 passes, before the first webbing first end 122 terminates in the connector 126A. The connector 126A may extend laterally out of the first side 116A of base 102. The first webbing second end 124 is positioned opposite the first webbing first end 122 at the opposite terminus of the length of the first webbing 120A. The first webbing second end 124 is attached to a biasing mechanism 130A, which in turn is coupled to a frame 132 at the front side 108 of the base 102.

Similarly, the second webbing 120B comprises a second webbing first end 134 and a second webbing second end 136. The second webbing first end 134 is attached to a connector 126B that is configured for releasable attachment to a vehicle anchor in a vehicle seat. In one example, the connector 126B may be an ISOFIX connector. The base 102 includes an opening 128B (visible in FIG. 1C) formed in the housing of the base 102, through which the second webbing first end 134 passes, before the second webbing first end 134 terminates in the connector 126B. The connector 126B may extend laterally out of the second side 116B of base 102. The second webbing second end 136 is positioned opposite the second webbing first end 134 at the opposite terminus of the length of the second webbing 120B. The second webbing second end 136 is attached to a biasing mechanism 130B, which in turn is coupled to the frame 132 at the front side 108 of the base 102. In the example shown in FIGS. 1A through 1C, the first and second webbings 120A and 120B, the openings 128A and 128B, and the biasing mechanisms 130A and 130B mirror the other in shape, size, placement, and orientation, as “reflected” across the longitudinal midline 118.

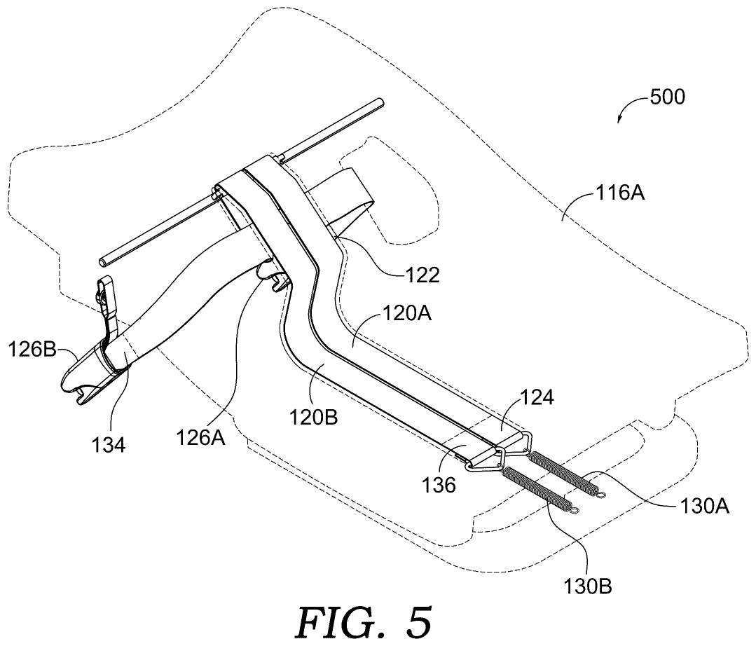

The bodies of the first and second webbings 120A and 120B, visible in FIG. 5, may be passed or threaded through a diverter body 208 that is centrally positioned between the first and second sides 116A and 116B of the base 102 and which is exposed and substantially flush with the top surface 112, as shown in FIGS. 1A through 1C. Although shown as a separate or distinct structure for clarity of discussion and simplicity in the figures, the diverter body 208 may be integrally formed with the base, such that the diverter body 208 may is a continuous and unitary portion formed as part of, and/or as within, the exterior and/or interior of the base 102, and/or the surfaces, edges, contours, and/or the like of the base 102, for example. As such, the diverter body 208 and its features discussed hereinafter, as will be understood from this Description, need not be formed as distinct, separable, and/or removable structures relative to the base 102.

The structure of the diverter body 208 guides portions of the body of the first webbing 120A and the body of the second webbing 120B through contact and features, further discussed herein. For example, the first webbing 120A passes into the first side 116A of the base 102, through the opening 128A in a lateral orientation, and is re-oriented or redirected into a longitudinal orientation based on contact with structures of the housing of the diverter body 208. Similarly, the second webbing 120B passes into the second side 116B of the base 102, through the opening 128B in a lateral orientation, and is re-oriented or redirected into a longitudinal orientation based on contact with structures of the housing of the diverter body 208. Further, the diverter body 208 guides the first webbing 120A and the second webbing 120B, after being oriented into a longitudinal orientation, into a webbing locking assembly 206, which as later discussed, moves concurrently with the arm assembly 104 when the arm assembly 104 is pivoted between the open and closed positions, to clamp and tension the webbings. In various aspects, the diverter body 208 may be a separate modular component that may be used with the base 102 and configured to interface with different modules.

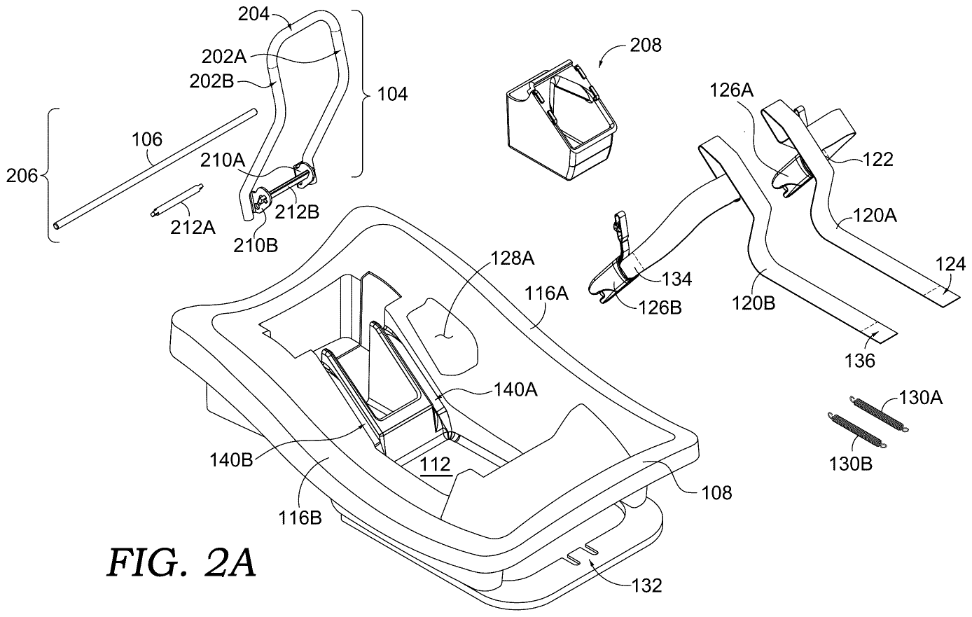

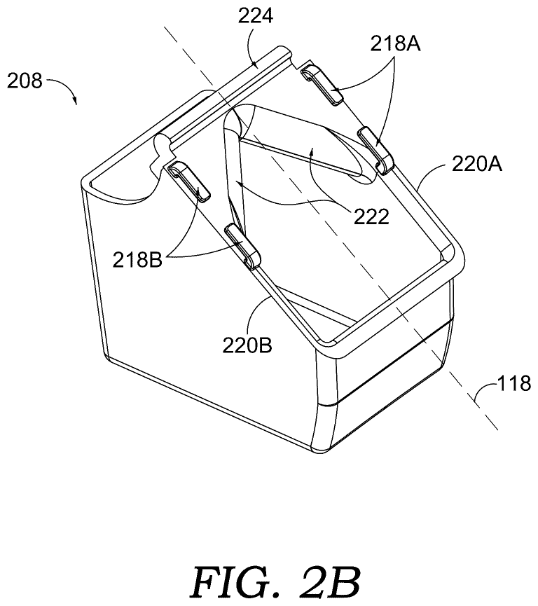

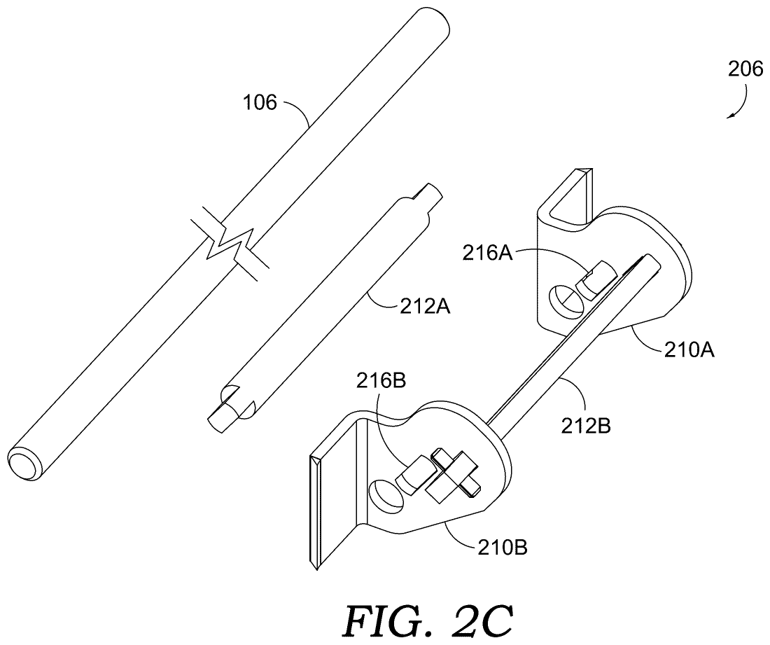

In the exploded view of the base 102 shown in FIG. 2A, the arm assembly 104 is depicted in an open position. The arm assembly 104 may have a U-shaped body, which includes a first elongated arm portion 202A corresponding to the first side 116A and a second elongated arm portion 202B corresponding to the second side 116B, which is positioned opposite the first elongated arm portion 202A and mirrored across the longitudinal midline 118. The arm assembly 104 may be connected to the pivot rod 106 at a proximal terminal end of each of the first and second elongated arm portions 202A and 202B, where the proximal arm region is opposite to a distal arm region of the first and second elongated arm portions 202A and 202B. The arm assembly 104 may be constructed of a single unitary piece or several pieces, in various aspects. The arm assembly 104 may be constructed from lightweight and rigid materials, for example, using lightweight alloys and/or high-strength polymers.

The arm assembly 104 includes a handle portion 204 that connects the first and second elongated arm portions 202A and 202B to each other in the distal arm region. The arm assembly 104 is pivotably connected to base 102 at or proximate to the top surface 112 of the base 102 as coupled to and connected to the pivot rod 106. The arm assembly 104 is movable between the open position of FIG. 1B and the closed position of FIG. 1A, as discussed above.

The top surface 112 of the base 102 may be contoured to form one or more cavities or recesses. These recesses may be sized, shaped, and positioned to accommodate one or more portions of the arm assembly 104 so that the arm assembly is recessed into the top surface 112 when the arm assembly 104 is in the closed position. The distal arm region may be moved downward toward the front side 108 and the top surface 112 of the base 102 and recessed therein so that a carrier shell may be positioned and secured within the base 102, as said components of the arm assembly 104 will not obstruct the carrier shell from being placed into the base 102. In various aspects, the top surface 112 includes a first groove 140A configured to receive the first elongated arm portion 202A and a second groove 140B configured to receive the second elongated arm portion 202B when the arm assembly 104 is placed into the closed position. The first and second grooves 140A and 140B may be elongated recesses arranged to be longitudinally oriented and extending between the front side 108 to the back side 110.

The handle portion 204 may provide a convenient hand-hold for a user to manually adjust the positioning of the arm assembly 104 between the closed and open positions. In some aspects, base 102 and the arm assembly 104 may include respective locking elements (not shown) to releasably lock the arm assembly 104 to the base 102 in the closed position. In an aspect, the locking element(s) may automatically lock upon closure. The locking element(s) may disengage through a separate release mechanism incorporated into one or more of the base 102 and/or the arm assembly 104, in some aspects. The arm assembly 104 may further include one or more biasing elements (not shown) that bias the arm assembly 104 into the open position or into the closed position. In other aspects, there is sufficient friction in the pivot rod 106 as connected to the arm assembly 104 to maintain the arm assembly 104 in the open position, closed position, or one or more intermediate positions therebetween. Thus, a user may not need to maintain the arm assembly 104 in a particular position, freeing them to maneuver the base 102, webbings, and connectors when securing the base 102 to the vehicle anchors.

The first and second elongated arm portions 202A and 202B are affixed and/or coupled to a first plate 210A and a second plate 210B, respectively, at or near the proximal arm region, as depicted in FIG. 2A. The first and second plates 210A and 210B may have any perimeter shape, may be planar in thickness, and may be vertically oriented such that the thinnest dimension of the first and second plates 210A and 210B is substantially orthogonal to the bottom surface 114.

Between the first and second plates 210A and 210B is a webbing locking assembly 206. The webbing locking assembly 206 includes a first transverse member 212A and a second transverse member 212B, referred to and labeled herein as a first “locking” bar 212A and a second “locking” bar 212B, respectively. The terms “rod” and “bar” are used interchangeably herein. Each of the first and second locking bars 212A and 212B may be coupled, affixed to, or secured to each of the first and second plates 210A and 210B. The first and second locking bars 212A and 212B traverse and span the distance between the first and second plates 210A and 210B. The first and second locking bars 212A and 212B are arranged to be parallel to each other in a lengthwise manner, are horizontally oriented as being orthogonal to the longitudinal midline 118, and are spaced apart or offset from each other. The pivot rod 106 may horizontally traverse and pass through openings formed in the first and second plates 210A and 210B, as well as openings formed in the proximal terminal ends of the arm assembly 104.

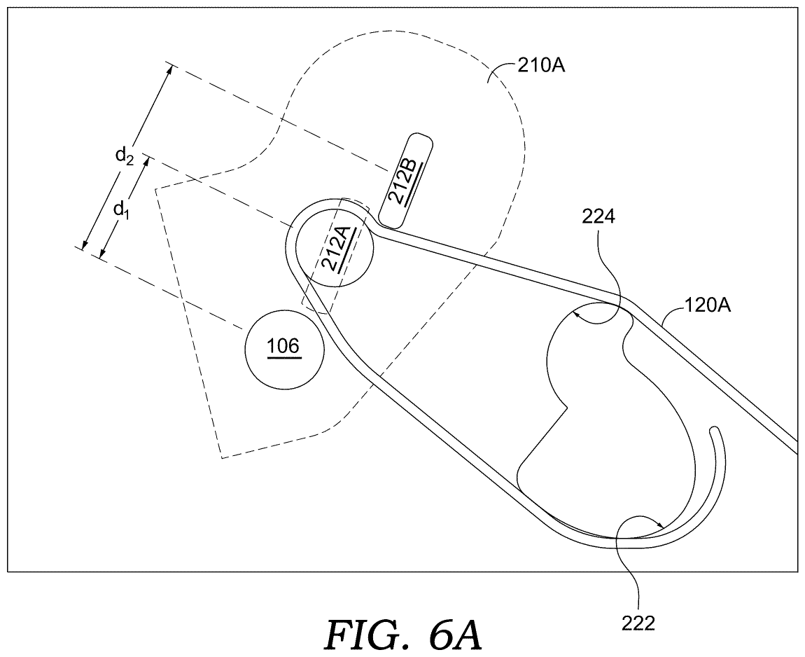

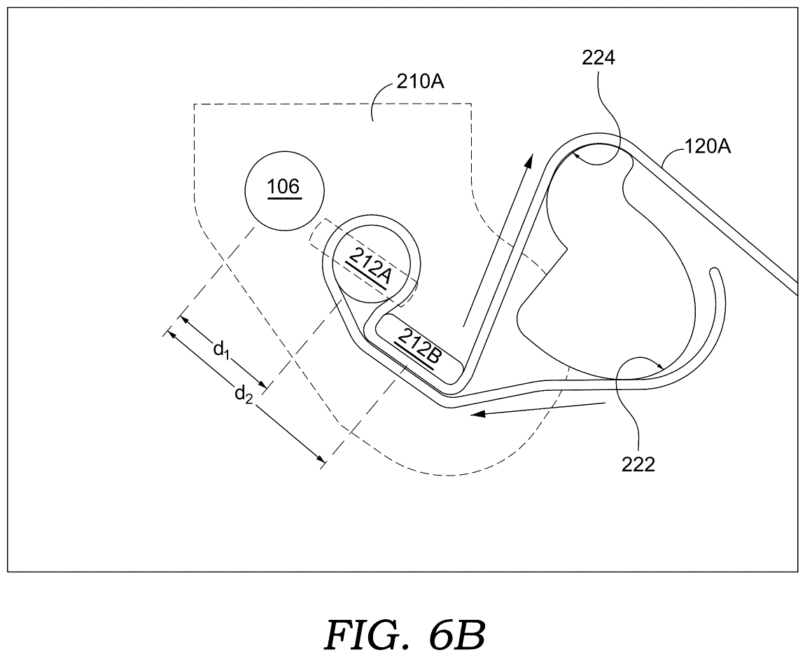

In the example shown in FIGS. 2A and 6A-B, the first locking bar 212A has a cylindrical body with a circular cross-section along its length and a pair of opposing flattened terminal ends extending from the cylindrical body. The flattened terminal ends may be inserted and received into elongated openings or slots 216A and 216B that are formed in each of the first and second plates 210A and 210B, as depicted in the example depicted in FIGS. 2A and 2C. Other shapes, sizes, and dimensions of the locking bar and the slots are contemplated to be within the scope of this disclosure. Additionally, the elongated slots 216 may be positioned and dimensioned so that the flattened ends of the first locking bar 212A may move or have “play” when inserted into the elongated slots 216, thus allowing the first locking bar 212A to slip or slide towards or away from the second locking bar 212B within the elongated slots 216 while maintaining a parallel orientation with the first locking bar 212A. Thus, the slots 216 may be larger than the cross-sectional profile or shape of the flattened ends. As described hereinafter, this sliding effect may be leveraged for tensioning and secure webbing.

The second locking bar 212B in the examples depicted in FIGS. 2A and 6A-B has a body with a planar, flattened shape, and a non-circular cross-section. However, other shapes, sizes, and dimensions are contemplated to be within the scope of this disclosure. The second locking bar 212B may be secured, affixed, and/or coupled to and positioned between the first and second plates 210A and 210B. In one aspect, the second locking bar 212B may be inserted into and retained by openings formed in each of the first and second plates 210A and 210B using fasteners (e.g., bolts, screws, rivets, welds, and the like) to secure the second locking bar 212B into place. Alternatively, the second locking bar 212B may be integrally formed with the first and second plates 210A and 210B. In contrast to the first locking bar 212A, the second locking bar 212B is static and does not slip or move as coupled to or formed with the first and second plates 210A and 210B.

While the first and second locking bars 212A and 212B are horizontally oriented along their length, relative to the bottom surface 114, the first and second locking bars 212A and 212B are offset from the horizontal rotation axis of the pivot rod 106, as depicted in FIGS. 2A and 6A-B. The first locking bar 212A may be offset or “spaced” a first distance d1 from the horizontal rotation axis of the pivot rod 106 and the second locking bar 212B may be offset or “spaced” a second distance d2 from the horizontal rotation axis of the pivot rod 106, where the second distance d2 is greater than the first distance d1. In other words, the second locking bar 212B is physically positioned farther away from the rotational axis of the pivot rod 106 relative to the first locking bar 212A. The first and second locking bars 212A and 212B of the webbing locking assembly 206 interact with each of the first webbing 120A and the second webbing 120B when the arm assembly 104 is in a closed position. As described hereinafter in detail, the cylindrical body of the first locking bar 212A interacts with the webbing to allow for slide over the curved profile when the arm assembly 104 is in the open position, whereas the flattened bar shape of the second webbing 120B interacts with the webbing to frictionally and forcibly secure the webbing in place when the arm assembly 104 is in the closed position.

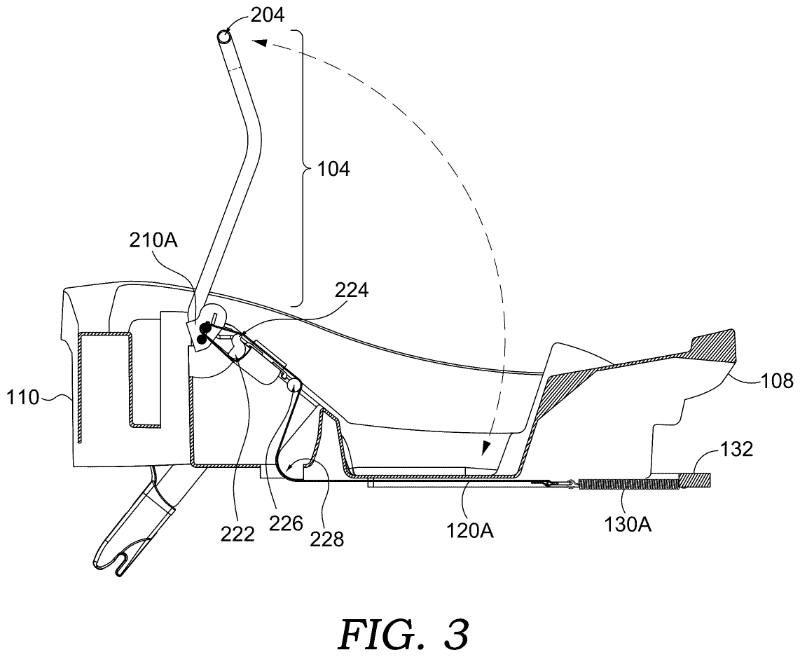

Looking to FIGS. 2A-B and FIGS. 3-5, the routing pathway 500 of the first and second webbings 120A and 120B through the base 102 will now be described. A diverter body 208 may be positioned in the base 102. The diverter body 208 may be formed of a rigid but flexible material, and may have a substantially hollow interior that may form or include openings to allow webbing to enter and exit said diverter body 208. For example, one opening (e.g., a “first” opening) may be formed to allow entry of the webbing into the diverter body 208 whereas another opening (e.g., a “second” opening) may allow exit of the webbing from the diverter body 208. As such, the diverter body 208 and its components (e.g., guide structures and edges) are robust and unlikely to break or crack in response to the contact, wear and tear of, and the pulling and tensioning forces of the webbing exerted on the diverter body 208 despite the substantially hollow interior.

The diverter body 208 may be being positioned within or recessed into the base 102 in a centralized location and positioned between the first and second elongated arm portions 202A and 202B when in a closed position. The first webbing 120A may enter into the base 102 in a lateral orientation at the first side 116A, may be guided through opening 128A, and may be guided under a pair of opposing flange projections that form a first guide structure 218A (visible in the magnified view shown in FIG. 2B) positioned at the first side upper edge 220A of the diverter body 208, and inward toward the longitudinal midline 118. Similarly, the second webbing 120B may enter into the base 102 in a lateral orientation at the second side 116B, may be guided through opening 128B, and further guided under and between a pair of opposing flange projections that form as second guide structure 218B. The second guide structure 218B may be positioned at a second upper side edge 220B the diverter body 208, and inward toward the longitudinal midline 118, thus mirroring the path of the first webbing 120A. Further, the guide structures mirror each other in shape, size, placement, and orientation, as “reflected” across the longitudinal midline 118.

The first and second webbings 120A and 120B are redirected by the diverter body 208 from their lateral orientation using a first diverter 222. The first and second webbings 120A and 120B pass from the side, over the first diverter 222 and wrap around said first diverter 222, which “folds” and re-orients the first and second webbings 120A and 120B into a longitudinal orientation. As shown, the longitudinal orientation is substantially orthogonal to the lateral orientation. In aspects, the first diverter 222 is a lip or edge having a “V-shape” formed by the meeting of two sloped angled surfaces that meet at a midline of the diverter body 208. The two sloped angled edges are arranged at an angle of about and/or substantially 45 degrees, measured as an interior angle formed between the longitudinal midline of the base 102 to each angled edge of the first diverter 222, and mirror one another. The first diverter 222 thus reorients the first and second webbings 120A and 120B using the first diverter 22 and a corresponding opening (i.e., a first opening formed to allow entry of the webbing into the diverter body 208) and guides the first and second webbings 120A and 120B downward through said opening within the diverter body 208 along the routing pathway 500.

The diverter body 208 further routes the first and second webbings 120A and 120B through the webbing locking assembly 206. The webbing locking assembly 206 moves along with the arm assembly 104 when the arm assembly 104 is pivoted between the open and closed positions to secure the first and second webbings 120A and 120B.

With regard to the webbing locking assembly 206, the first and second webbings 120A and 120B, now longitudinally oriented by the first diverter 222 of the diverter body 208, pass toward the back side 110 of the base 102 and through an opening (e.g., a second opening that allows exit of the webbing from the diverter body 208), then between the pivot rod 106 and the first locking bar 212A, as shown in FIG. 3 and FIG. 6A. As such, the first and second webbings 120A and 120B pass behind, upward, and over the first locking bar 212A. The first and second webbings 120A and 120B are then directed beneath or below the second locking bar 212B and toward the second diverter 224, as shown in FIG. 6A. The second diverter 224 includes a convex lip and/or a curved, smooth surface configured to enable the webbing to glide over the surface without catching or snagging. The second diverter 224 may be a surface or lip having a hemispherical cross-section taken parallel to the longitudinal midline 118, as visible in the cross-sectional view in each of FIGS. 3, 4, and 6A-B. As such, the first and second webbings 120A and 120B are “laced” through the gap formed between the first and second locking bars 212A and 212B. The second diverter 224 comprises a curved or rounded lip that projects upward from the diverter body 208. Then, the second diverter 224 directs the first and second webbings 120A and 120B over and above the upper surface of the diverter body 208 toward the front side 108. The second diverter 224 prevents the first and second webbings 120A and 120B from contacting or interfering with first and second guide structures 216A and 216B and the first diverter 222, as well as those portions of the webbing that presently pass through the first and second guide structures 218A and 218B and the first diverter 222. As such, the webbing “floats above” the first and second guide structures 218A and 218B, so that the webbing is guided by the second diverter 224 and does not contact other portions of the same webbing.

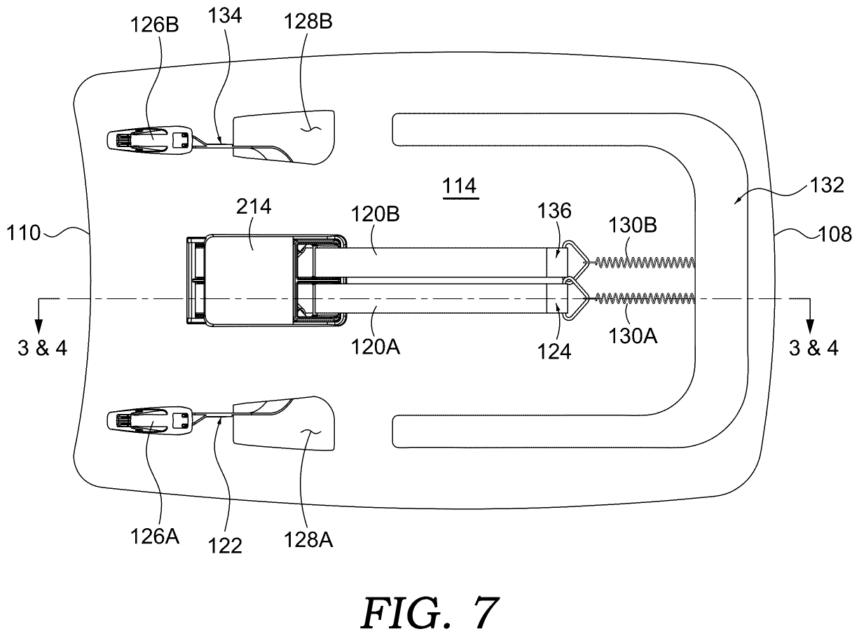

The first and second webbings 120A and 120B are further routed toward the front side 108 and around a third diverter 226 and a fourth diverter 228. The third diverter 226 comprises, for example, a roller or a rounded surface configured to enable the webbing to glide over the surface without catching or snagging. The third diverter 226 may be a surface or lip having a spherical or hemispherical cross-section taken parallel to the longitudinal midline 118, as visible in the cross-sectional view in each of FIGS. 3, 4, and 6A-B. The third diverter 226 redirects the first and second webbings 120A and 120B downward, toward the bottom surface 114. After passing by the third diverter 226, a fourth diverter 228 further redirects the first and second webbings 120A and 120B toward the front side 108 proximate to and parallel with the bottom surface 114 while remaining within the housing of the base 102, so that the first webbing second end 124 and the second webbing second end 136, respectively, connect to the respective biasing mechanisms 130A and 130B. In this aspect, having separate biasing mechanisms 130A and 130B that connect to respective and separate webbing allows flexibility in positioning the base 102 relative to the vehicle anchors, as visible in FIG. 7. That is, the base 102 can be placed between vehicle anchors without precision, since the first webbing 120A and the second webbing 120B may be independently tensioning and adjusted by respective biasing mechanisms 130A and 130B before the arm assembly 104 is moved to the closed position.

Each of the first diverter 222, the second diverter 224, the third diverter 226, and the fourth diverter 228 may have a smooth, curved surface to allow for reduced friction that promotes gliding and sliding of the first and second webbings 120A and 120B, to minimize wear and tear, and to prevent snags or catching of the webbings as they pass through the diverter body 208. The second diverter 224, the third diverter 226, and the fourth diverter 228 may be oriented and arranged in a horizontal plane, and parallel to each other, so as to be orthogonal to the longitudinal midline of the base 102, in some aspects.

Although the routing pathway is at least partially unenclosed relative to the base 102, it is contemplated that a routing pathway having partially enclosed portions is within the scope of the present disclosure. Additional components used to define the routing pathway 500 that are not part of a dedicated diverter body 208, such as fourth diverter 228, may be formed as separate components to be separately attached to or integrally formed with the base 102. Moreover, it will be understood that, while a series of diverters and their shapes are described herein for the routing pathway 500, these are merely examples and fewer or more edges, lips, or other routing mechanisms and other pathways connecting the webbing to the biasing mechanisms could be utilized and are contemplated to be within the scope of this disclosure.

As described above, the first locking bar 212A may have a sliding movement within the slots 216 of the first and second plates 210A and 210B, and as such, the first locking bar 212A is positioned at a distance from the second locking bar 212B in the open position. As the first locking bar 212A is positioned when the arm assembly 104 is in the open position, the first locking bar 212A may shift in the slots based on gravity to increase and/or maximize the distance of the gap positioned between the first locking bar 212A and the second locking bar 212B through which the first and second webbings 120A and 120B pass. The first and second webbings 120A and 120B extend and wrap around the first locking bar 212A, then extend towards the upper surface 604 of the second diverter 224 through the gap between the first locking bar 212A and the second locking bar 212B. The sections of the first webbing 120A that pass through the gap do not contact one another, allowing for unhindered sliding of the first webbing 120A along the first locking bar 212A in reaction to pulling forces on the first webbing first end 122 and the first webbing second end 124 when the arm assembly 104 is in an open position.

When the arm assembly 104 is in the open position, pulling on a portion of the first webbing 120A and/or the first webbing first end 122 operates against the force of the biasing mechanism 130A connected to the first webbing second end 124, and this forces stretches the length of the biasing mechanism 130A, as shown in FIG. 7, for example. When the force of pulling force on the first webbing 120A and/or the first webbing first end 122 is greater than and/or exceeds the biasing force of the biasing mechanism 130A, the first webbing 120A slides along the routing pathway 500, and the first webbing first end 122 may be extended away from the base 102, allowing a user to couple the connector 126A to a vehicle anchor. This may be similarly performed with the second webbing 120B. For example, once the connector 126A is connected to the vehicle anchor and the first webbing 120A is released by a user, the biasing force of the biasing mechanism 130A is unopposed by the user, and the first webbing 120A is pulled along the routing pathway 500 in response to the biasing force. As such, the biasing mechanism 130A retracts excess length and slack from the first webbing. This causes the first webbing 120A to become taut along the routing pathway 500, as well as taut between the first guide structure 218A and the connection with the vehicle anchor. This may be similarly performed with the second webbing 120B.

In various aspects, the first and second webbings 120A and 120B, the biasing mechanisms 130A and 130B, the first and second guide structures 218A and 218B, the diverter body 208, or any combination thereof may be configured to limit the maximum length to which a webbing can extend outward from a guide structure and outward from the base 102. In some aspects, a maximum length of a webbing may be determined by the structure and configuration of the webbing itself, whether alone, or in combination with a biasing mechanism. For example, when the biasing mechanisms 130A and 130B are torsion springs as shown in FIG. 7, a mechanical structure and/or another structure may be used to prevent the torsion spring from extending beyond a defined maximum length or to otherwise prevent a particular portion of the corresponding webbing from passing through a particular structure, opening, and/or the like.

Continuing, when the connector 126A is disconnected from the vehicle anchor and released, the biasing mechanism 130A pulls the first webbing 120A back into the base, shortening the length of the first webbing 120A that extends outside of the first side 116A of the base 102. In various aspects, the first webbing 120A, biasing mechanism 130A, and/or guide structure 218A may be configured to limit the amount of first webbing 120A that can be pulled into the base 102. This prevents the first webbing first end 122 from being “lost” within the base 102, and inaccessible to a user. For example, the length of the first webbing 120A may be selected so that when the biasing mechanism 130A is in a relaxed state, there is a minimum length of the first webbing 120A that still extends out from the first guide structure 216A. Alternatively, a stop may be added to the first webbing 120A at a particular distance from the first webbing first end 122 that is larger than the slot of the first guide structure 218A, so that the first webbing 120A cannot be retracted further once the stop reaches the first guide structure 218A. In some aspects, the connectors 126A may also serve as physical stops when they reach the first guide structure 216A to prevent the first webbing 120A from being drawn completely through the first guide structure 216A and into the base 102. The same or similar aspects may be used for the second webbing 120B.

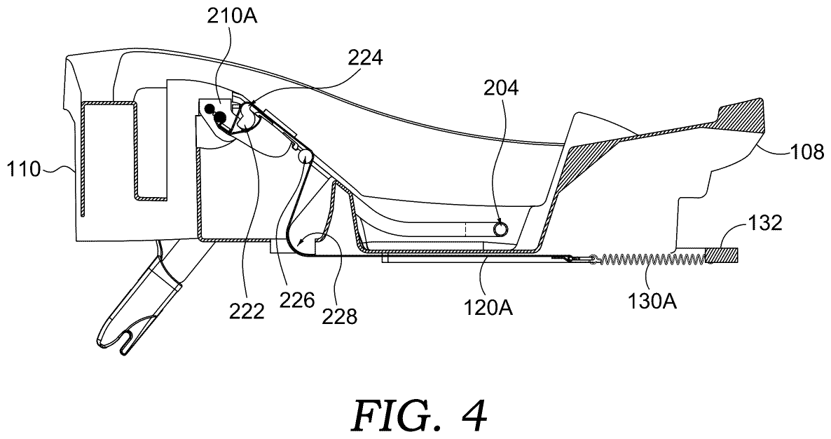

Turning to FIGS. 4 and 6B, the arm assembly 104 is depicted as having been rotated downward, toward the upper surface 112, into the grooves 140A and 140B, and into the closed position. As the handle portion 204 of the arm assembly 104 is rotated about the pivot rod 106 and toward the base, the biasing mechanism 130A continues to exert a pull on the first webbing second end 124. This assists in holding the first webbing 120A taut by removing slack along the routing pathway 500 of the first webbing 120 from the biasing mechanism 130A all the way to the first webbing first end 124 where the connector 126A, for example, may be attached to a vehicle anchor. At the same time, when the handle portion 204 of the arm assembly 104 is rotated about the pivot rod 106 and toward the upper surface 112 of the base 102, the first locking bar 212A and the second locking bar 212B of the webbing locking assembly 206 are also rotated around the rotational axis of the pivot rod 106, as shown in FIG. 6B, while the first and second webbings 120A and 120B remain threaded between the gap formed between the first locking bar 212A and the second locking bar 212B. When the first and second locking bars 212A and 212B are rotated, the flattened surface of the second locking bar 212B comes into contact with the first webbing 120A and exerts a force that presses the first webbing 120A into another portion of the first webbing 120A, as shown in FIG. 6B. The relatively larger and flattened surface of the second locking bar 212B shown in FIG. 6B provides relatively greater surface area that contacts and exerts downward force upon the first webbing 120 in FIG. 6B, relative to the lesser surface area contact shown between the second locking bar 212B and the first webbing 120A in FIG. 6A. This increased surface area of the second locking bar 212B being in contact with the first webbing 120A also increases the surface area of the first webbing 120A that is in contact with the other portion of the first webbing 120A shown in FIG. 6B. This increases and promotes surface friction between the contracting portions of the first webbing 120A, thus further securing the first webbing 120A into place, relative to the second locking bar 212B, and which prevents slippage of the webbing. The same procedure, forces, and tensioning are concurrently performed on the second webbing 120B when the arm assembly 104 is moved to the closed position, though not repeated herein for brevity.

As shown, the total “locking” length of the first webbing 120A, as measured from the first diverter 222 to the second diverter 224 is generally fixed in length, due to the biasing mechanism removing slack and excess webbing length along the routing pathway 500 of the first webbing 120A, from the first webbing second end 124 back to the connector 126A that is attached to a vehicle anchor. The “open configuration” distance of the routing pathway 500, measured from the second diverter 224 to the third diverter 226, is less than the “closed configuration” distance of the routing pathway 500, measured from the second diverter 224 to the third diverter 226. Thus, when the first locking bar 212A and the second locking bar 212B are rotated and used to clamp the first webbing 120A in place as shown in FIG. 6B, the total and fixed “locking” length of the first webbing 120A is stretched taut from the “open configuration” distance to the greater length of the “closed configuration” distance of the routing pathway 500—which further tensions the webbing by removing any excess or residual webbing length that may remain despite the efforts of the biasing mechanism 130A. The same procedure, forces, and tensioning are concurrently performed on the second webbing 120B when the arm assembly 104 is moved to the closed position, though not repeated herein for brevity.

Moreover, the first locking bar 212A may shift within the slots 216 to reduce and/or minimize the size, width, or distance of the gap between the first locking bar 212A and the second locking bar 212B, based on gravity and/or the rotation of the arm assembly 104. The same procedure, forces, and tensioning are concurrently performed on the second webbing 120B when the arm assembly 104 is moved to the closed position, though not repeated herein for brevity.

Accordingly, the combination of the biasing mechanism 130A exerting a pulling force from the direction of the first webbing second end 124, the clamping effect of the first and second locking bars 212A and 212B, and the locking length being pulled taut to the closed configuration distance of the routing pathway 500 all work together to ensure appropriate and sufficient tensioning of the first webbing 120A. The same procedure, forces, and tensioning are concurrently performed on the second webbing 120B when the arm assembly 104 is moved to the closed position, though not repeated here for brevity.

Further still, when the arm assembly 104 is rotated downward toward and into the closed position, laterally oriented portions of the first and second webbings 120A and 120B are wrapped under and around the curved shape of the first and second arm elongated arm portions 202A and 202B. By “wrapping around” the arm portions, some length of the first and second webbings 120A and 120B is tautened, and/or slack is removed. The first and second arm elongated arm portions 202A and 202B contact and exert downward pressure onto said laterally oriented portions of the first and second webbings 120A and 120B, pressing said portions into the first and second grooves 140A and 140B, which act as locking surfaces, as visible in FIG. 1A. This arm-to-groove clamping may occur before, during, or concurrently with the actions of the webbing locking assembly 206. When the arm-to-groove fit occurs before and/or during the tensioning performed by the webbing locking assembly 206, it may prevent the arm assembly 104 from pulling additional length of the first and second webbings 120A and 120B through the first and second guide structures 218A and 218B, and assist in tensioning the first and second webbings 120A and 120B.

“A,” “an,” “the,” “at least one,” and “one or more” are used interchangeably to indicate that at least one of the items is present. A plurality of such items may be present unless the context clearly indicates otherwise. All numerical values of parameters (e.g., of quantities or conditions) in this specification, unless otherwise indicated expressly or clearly in view of the context, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; or nearly). If the imprecision provided by “about” is not otherwise understood in the art with this ordinary meaning, then “about” as used herein indicates at least variations that may arise from ordinary methods of measuring and using such parameters. As used in the description and the accompanying claims, a value is considered to be “approximately” equal to a stated value if it is neither more than 5 percent greater than nor more than 5 percent less than the stated value. In addition, a disclosure of a range is to be understood as specifically disclosing all values and further divided ranges within the range.

The terms “comprising,” “including,” and “having” are inclusive and therefore specify the presence of stated features, steps, operations, elements, or components, but do not preclude the presence or addition of one or more other features, steps, operations, elements, or components. Orders of steps, processes, and operations may be altered when possible, and additional or alternative steps may be employed. As used in this specification, the term “or” includes any one and all combinations of the associated listed items. The term “any of” is understood to include any possible combination of referenced items, including “any one of” the referenced items. The term “any of” is understood to include any possible combination of referenced claims of the appended claims, including “any one of” the referenced claims.

For consistency and convenience, directional adjectives may be employed throughout this detailed description corresponding to the illustrated aspects and aspects. Those having ordinary skill in the art will recognize that terms such as “above,” “below,” “upward,” “downward,” “top,” “bottom,” etc., may be used descriptively relative to the figures, without representing limitations on the scope of the disclosure, as defined by the claims.

The following clauses represent example aspects of concepts contemplated herein. Any one of the following clauses may be combined in a multiple dependent manner to depend from one or more other clauses. Further, any combination of dependent clauses (clauses that explicitly depend from a previous clause) may be combined while staying within the scope of aspects contemplated herein. The following clauses are examples and are not limiting.
Clause 1. A child safety seat assembly comprising: a base body; a biasing mechanism attached to the base body; and a webbing that comprises a webbing body, a first end, and a second end, wherein: the first end is configured for connection to a vehicle anchor; the second end is attached to the biasing mechanism; and the webbing body is disposed along a routing pathway; and a webbing locking assembly movable between an open position and a closed position; and wherein when the webbing locking assembly is in the open position, the webbing body moves along the routing pathway when a pulling force is applied to the first end, and the biasing mechanism is configured to exert an opposing pulling force on the webbing body at the second end, and when the webbing locking assembly is in the closed position, the webbing locking assembly is configured to limit movement of the webbing body along the routing pathway.
Clause 2. The child safety seat assembly of clause 1, wherein: the webbing locking assembly comprises a first transverse member and a second transverse member, each of the first transverse member and the second transverse member extending between a first plate member and a second plate member; and wherein a portion of the webbing body passes between the first transverse member and the second transverse member along the routing pathway.
Clause 3. The child safety seat assembly of clauses 1-2, wherein the first transverse member engages elongated openings formed in the first plate member and the second plate member.
Clause 4. The child safety seat assembly of clauses 1-3, further comprising an arm connected to the base body by a pivot member and extending in a first direction that longitudinally extends from the pivot member toward a front of the base body.
Clause 5. The child safety seat assembly of clauses 1-4, wherein the arm is movable about the pivot member between the open position and the closed position, and wherein moving the arm about the pivot member further moves the webbing locking assembly between the open position and the closed position.
Clause 6. The child safety seat assembly of clauses 1-5, wherein when the webbing locking assembly is moved between the open position and the closed position, the first transverse member slidably moves within the elongated openings.
Clause 7. The child safety seat assembly of clauses 1-6, wherein the first transverse member and the second transverse member are positioned between the pivot member and a handle portion of the arm.
Clause 8. The child safety seat assembly of clauses 1-7, wherein when the arm is in the closed position, the arm is configured to apply a downward force to the webbing body to secure the webbing body against a locking surface of the base body.
Clause 9. The child safety seat assembly of clauses 1-8, wherein the locking surface is a groove formed in the base body, the groove is configured to receive a transverse-oriented portion of the webbing body and at least a portion of the arm when the webbing locking assembly and the arm are in the closed position.
Clause 10. A child safety seat assembly comprising: a base body that comprises a routing pathway, a first opening, and a second opening, the first opening oriented in a first direction and the second opening oriented in a second direction; and a pivot member; a webbing that comprises a webbing body that is disposed along the routing pathway, a first end, and a second end, wherein: the first end is configured for connection to a vehicle anchor; the second end is attached to the base body; and a first portion of the webbing body that is between the first end and the second end is disposed along the routing pathway; and a webbing locking assembly movable about the pivot member between an open position and a closed position; and wherein: the webbing locking assembly, in the closed position, engages the webbing body at a first location between the first opening of the base body and the second end of the webbing, and engages the webbing body at a second location between the second opening of the base body and the first end of the webbing.
Clause 11. The child safety seat assembly of clause 10, wherein the webbing locking assembly comprises an arm that is rotatable around the pivot member, that is connected to the base body via the pivot member, and that extends longitudinally from the pivot member toward a front of the base body.
Clause 12. The child safety seat assembly of clauses 10-11, wherein the second location is a locking surface on the base body that the arm, in the closed position, applies a downward force to a second portion of the webbing body to secure the webbing body between the arm and the locking surface.
Clause 13. The child safety seat assembly of clauses 10-12, wherein the locking surface is a groove on the base body that is aligned with and configured to receive the arm.
Clause 14. The child safety seat assembly of clauses 10-13, wherein the webbing locking assembly further comprises a first transverse member extending in a transverse direction relative to the arm.
Clause 15. The child safety seat assembly of clauses 10-14, wherein the webbing locking assembly further comprises a second transverse member extending in the transverse direction relative to the arm, and a portion of the webbing is positioned between the first transverse member and the second transverse member along the routing pathway.
Clause 16. The child safety seat assembly of clauses 10-15, wherein the first transverse member and the second transverse member are positioned between the pivot member and a distal end of the arm and are positioned nearer the pivot member than the distal end of the arm.
Clause 17. The child safety seat assembly of clauses 10-16, wherein the first direction is perpendicular to the second direction.
Clause 18. A child safety seat assembly comprising: a base body comprising a routing pathway, a first opening, and a second opening, the first opening being oriented in a first direction and the second opening being oriented in a second direction; a biasing mechanism attached to the base body; and a webbing comprising a webbing body, a first end, and a second end, wherein: the first end is configured for connection to a vehicle anchor; the second end is attached to the biasing mechanism; and at least a portion of the webbing body that is between the first end and the second end is disposed along the routing pathway; and a webbing locking assembly movable between an open position and a closed position; and wherein: when the webbing locking assembly is in the open position, the webbing body shifts along the routing pathway when a pulling force applied to the first end, and the biasing mechanism is configured to exert an opposite pulling force from the second end; and when in the closed position, the webbing locking assembly is configured to limit movement of the webbing body at a first location between the first opening of the base body and the second end of the webbing and at a second location between the second opening of the base body and the first end of the webbing.
Clause 19. The child safety seat assembly of clause 18, wherein the webbing locking assembly, when moving from the open position to the closed position, engages the webbing body at the first location before engaging the webbing body at the second location, to limit movement of the webbing body.
Clause 20. The child safety seat assembly of clauses 18-19, wherein the webbing locking assembly comprises an arm pivotably connected to the base body and rotatably connected via the pivot member.

Many different arrangements of the various components depicted, as well as components not shown, are possible without departing from the scope of the claims below. Aspects in this disclosure are described with the intent to be illustrative rather than restrictive. Alternative aspects will become apparent to readers of this disclosure after and because of reading it. Alternative means of implementing the aforementioned can be completed without departing from the scope of the claims below. Some features and subcombinations are of utility and may be employed without reference to other features and subcombinations and are contemplated within the scope of the claims.

In the preceding detailed description, reference is made to the accompanying drawings which form a part hereof wherein like numerals designate like parts throughout, and in which is shown, by way of illustration, aspects that may be practiced. It is to be understood that other aspects may be utilized and structural or logical changes may be made without departing from the scope of the present disclosure. Therefore, the preceding detailed description is not to be taken in the limiting sense, and the scope of aspects is defined by the appended claims and their equivalents.

What is claimed is:

1. A child safety seat assembly comprising:
a base body;
a biasing mechanism attached to the base body; and
a webbing that comprises a webbing body, a first end, and a second end, wherein:
the first end is configured for connection to a vehicle anchor;
the second end is attached to the biasing mechanism; and
the webbing body is disposed along a routing pathway; and
a webbing locking assembly movable between an open position and a closed position; and
wherein when the webbing locking assembly is in the open position, the webbing body moves along the routing pathway when a pulling force is applied to the first end, and the biasing mechanism is configured to exert an opposing pulling force on the webbing body at the second end, and
when the webbing locking assembly is in the closed position, the webbing locking assembly is configured to limit movement of the webbing body along the routing pathway.

2. The child safety seat assembly of claim 1, wherein:
the webbing locking assembly comprises a first transverse member and a second transverse member, each of the first transverse member and the second transverse member extending between a first plate member and a second plate member; and
wherein a portion of the webbing body passes between the first transverse member and the second transverse member along the routing pathway.

3. The child safety seat assembly of claim 2, wherein the first transverse member engages elongated openings formed in the first plate member and the second plate member.

4. The child safety seat assembly of claim 3, further comprising an arm connected to the base body by a pivot member and extending in a first direction that longitudinally extends from the pivot member toward a front of the base body.

5. The child safety seat assembly of claim 4, wherein the arm is movable about the pivot member between the open position and the closed position, and wherein moving the arm about the pivot member further moves the webbing locking assembly between the open position and the closed position.

6. The child safety seat assembly of claim 5, wherein when the webbing locking assembly is moved between the open position and the closed position, the first transverse member slidably moves within the elongated openings.

7. The child safety seat assembly of claim 6, wherein the first transverse member and the second transverse member are positioned between the pivot member and a handle portion of the arm.

8. The child safety seat assembly of claim 5, wherein when the arm is in the closed position, the arm is configured to apply a downward force to the webbing body to secure the webbing body against a locking surface of the base body.

9. The child safety seat assembly of claim 8, wherein the locking surface is a groove formed in the base body, the groove is configured to receive a transverse-oriented portion of the webbing body and at least a portion of the arm when the webbing locking assembly and the arm are in the closed position.

10. A child safety seat assembly comprising:
a base body that comprises a routing pathway, a first opening, and a second opening, the first opening oriented in a first direction and the second opening oriented in a second direction; and
a pivot member;
a webbing that comprises a webbing body that is disposed along the routing pathway, a first end, and a second end, wherein:
the first end is configured for connection to a vehicle anchor;
the second end is attached to the base body; and
a first portion of the webbing body that is between the first end and
the second end is disposed along the routing pathway; and
a webbing locking assembly movable about the pivot member between an open position and a closed position; and
wherein:
the webbing locking assembly, in the closed position, engages the webbing body at a first location between the second opening of the base body and the second end of the webbing, and engages the webbing body at a second location between the first opening of the base body and the first end of the webbing.

11. The child safety seat assembly of claim 10, wherein the webbing locking assembly comprises an arm that is rotatable around the pivot member, that is connected to the base body via the pivot member, and that extends longitudinally from the pivot member toward a front of the base body.

12. The child safety seat assembly of claim 11, wherein the second location is a locking surface on the base body that the arm, in the closed position, applies a downward force to a second portion of the webbing body to secure the webbing body between the arm and the locking surface.

13. The child safety seat assembly of claim 12, wherein the locking surface is a groove on the base body that is aligned with and configured to receive the arm.

14. The child safety seat assembly of claim 11, wherein the webbing locking assembly further comprises a first transverse member extending in a transverse direction relative to the arm.

15. The child safety seat assembly of claim 14, wherein the webbing locking assembly further comprises a second transverse member extending in the transverse direction relative to the arm, and a portion of the webbing is positioned between the first transverse member and the second transverse member along the routing pathway.

16. The child safety seat assembly of claim 15, wherein the first transverse member and the second transverse member are positioned between the pivot member and a distal end of the arm and are positioned nearer the pivot member than the distal end of the arm.

17. The child safety seat assembly of claim 10, wherein the first direction is perpendicular to the second direction.

18. A child safety seat assembly comprising:
a base body comprising a routing pathway, a first opening, and a second opening, the first opening being oriented in a first direction and the second opening being oriented in a second direction;
a pivot member;
a biasing mechanism attached to the base body; and
a webbing comprising a webbing body, a first end, and a second end, wherein:
the first end is configured for connection to a vehicle anchor;
the second end is attached to the biasing mechanism; and
at least a portion of the webbing body that is between the first end
and the second end is disposed along the routing pathway; and
a webbing locking assembly movable between an open position and a closed position about the pivot member; and
wherein:
when the webbing locking assembly is in the open position, the webbing body shifts along the routing pathway when a pulling force applied to the first end, and the biasing mechanism is configured to exert an opposite pulling force from the second end; and
the webbing locking assembly, in the closed position, engages the webbing body at a first location between the second opening of the base body and the second end of the webbing, and engages the webbing body at a second location between the first opening of the base body and the first end of the webbing.

19. The child safety seat assembly of claim 18, wherein the webbing locking assembly, when moving from the open position to the closed position, engages the webbing body at the first location before engaging the webbing body at the second location, to limit movement of the webbing body.

20. The child safety seat assembly of claim 19, wherein the webbing locking assembly comprises an arm pivotably connected to the base body and rotatably connected via the pivot member.
